(19) United States
(12) Patent Application Publication
(10) Pub. No.: US 2026/0131336 A1
(43) Pub. Date: May 14, 2026

(54) APPARATUS AND METHOD FOR UNIFORMLY PROCESSING POWDER MATERIAL USING INTENSE PULSED LIGHT

(71) Applicants: VITZROCELL CO. LTD., Dangjin-si, Chungcheongnam-do (KR); MAKESENS INC., Calgary, Alberta (CA)

(72) Inventors: Simon PARK, Calgary, Alberta (CA); Chaneel PARK, Calgary, Alberta (CA); Hongseok CHO, Calgary, Alberta (CA); Jong-Song KIM, Dangjin-si, Chungcheongnam-do (KR); Kyoung-Soo PARK, Dangjin-si, Chungcheongnam-do (KR); Ji-Hoon KANG, Dangjin-si, Chungcheongnam-do (KR)

(21) Appl. No.: 19/111,522

(22) PCT Filed: Aug. 25, 2023
(86) PCT No.: PCT/KR2023/012680

§ 371 Date: Mar. 13, 2025

(30) Foreign Application Priority Data
Sep. 16, 2022 (KR) 10-2022-0117216

(51) Int. Cl. B03C 3/017; B01J 2/16; C01B 32/05; C08J 7/18

(52) U.S. Cl. CPC B03C 3/017; B01J 2/16; C01B 32/05; C08J 7/18

(57) ABSTRACT

An apparatus and a method for processing a powder material using IPL are disclosed. The powder material processing apparatus includes a chamber; a raw-powder feeding line for feeding raw-powders having a polymer coating into the chamber; a gas ejector disposed on a bottom of the chamber so as to eject air upwardly to suspend the raw-powders in the chamber; an IPL (Intense Pulsed Light) irradiator for carbonizing the polymer coating of the raw-powders; and a treated-powder discharging line for discharging treated-powders having the carbonized polymer coating out of the chamber.

### TECHNICAL FIELD

The present disclosure relates to techniques for preparation of powders such as anode/cathode powders for lithium secondary batteries.

More specifically, the present disclosure relates to an apparatus and a method for processing a powder material using Intense Pulsed Light (IPL).

### BACKGROUND ART

Demand for lithium secondary batteries, such as lithium ion batteries, is increasing because of application thereof to a wide range ranging from small and portable electronic products to large electric vehicles. The transition from fossil fuel vehicles to electric vehicles is becoming visible, and accordingly, interest in high-performance lithium secondary batteries is further increasing. A lot of research is underway to achieve higher capacity, longer lifespan, faster charging and improved safety of the lithium secondary batteries. One of them is to develop an anode and a cathode with higher energy density than before.

Silicon (Si) with a theoretical capacity of 4,200 mAh/g is attracting attention as an active material candidate for an anode of the lithium-based battery due to its high energy density. For the same reason, sulfur (S) with a theoretical capacity of 1,675 mAh/g is attracting attention as a candidate active material for a cathode of the lithium-based battery. However, each of silicon and sulfur is known to have large volume expansion during repeated lithiation processes. Such rapid volume change leads to pulverization and peeling-off of the active material, resulting in loss of electrode integrity and electrical insulation, thereby degrading battery performance.

In order to solve the problem related to the volume expansion of the active material, a method of processing a surface of the active material has been proposed.

Korean Patent Application Publication No. 10-2014-0034879 (published on Mar. 20, 2014) discloses a method of surface-treating silicon particles with a polymer such as polyalkylene oxide. In this document, the silicon particles are coated with the polymer, thereby preventing damage due to the volume change of the silicon particles during charging and discharging processes.

However, only coating the silicon particles with the polymer cannot provide structural rigidity to the silicon particles. As a result, it is difficult to suppress the volume expansion of the silicon particles.

To this end, it is necessary that an inner portion in a thickness direction of the polymer maintains in a polymer state, while an outer portion in the thickness direction of the polymer is hardened.

A method of hardening the outer portion in the thickness direction of the polymer may include a method of additionally coating a powder material having a polymer coating formed thereon with carbon or metal. However, in this method, a separate coating process is added, such that this is disadvantageous in terms of time and economy.

Another method of hardening the outer portion in the thickness direction of the polymer may include a method of carbonizing only the outer portion in the thickness direction of the polymer coating. In this method, a separate coating process may not be required. However, it is difficult to carbonize only the outer portion in the thickness direction of the polymer coating using a conventional heating method.

### DISCLOSURE OF INVENTION

### Technical Problem

A purpose of the present disclosure is to provide a powder material processing apparatus and method capable of uniformly carbonizing only an outer portion in a thickness direction of a polymer coating of a powder material having the polymer coating.

### Solution to Problem

A powder material processing apparatus according to the present disclosure for achieving the above purpose comprises a chamber; a raw-powder feeding line for feeding raw-powders having a polymer coating into the chamber; a gas ejector disposed on a bottom of the chamber so as to eject air upwardly to suspend or levitate the raw-powders in the chamber; an IPL (Intense Pulsed Light) irradiator for carbonizing the polymer coating of the raw-powders; and a treated-powder discharging line for discharging treated-powders having the carbonized polymer coating out of the chamber.

In one embodiment of the apparatus, the gas ejector ejects the air upwardly at a magnitude of an air pressure corresponding to a magnitude of a gravity applied to the raw-powders so that the gravity and a suspending force or a levitating force applied to the raw-powders are balanced with each other to suspend the raw-powders at a predetermined vertical level in the chamber, wherein the treated-powder discharging line is positioned at a vertical level higher than the predetermined vertical level so that the treated-powder which becomes lighter than the raw-powder via the carbonization is discharged out of the chamber by the gas ejector.

In one embodiment of the apparatus, the apparatus further comprises a compressed air supplier, wherein the compressed air supplier is in fluid communication with the raw-powder feeding line and the gas ejector.

In one embodiment of the apparatus, the apparatus further comprises a powder number counter disposed in each of the raw-powder feeding line and the treated-powder discharging line.

In one embodiment of the apparatus, a feedstock hopper is disposed at the raw-powder feeding line, or the raw-powder feeding line is connected to a discharging line of a raw-powder storage or a powder drier.

In one embodiment of the apparatus, the IPL irradiator is disposed on a side surface or an upper surface of the chamber. In this case, the apparatus further comprises a reflector covering an entirety of an inner surface except for a portion to which the IPL from the IPL irradiator is irradiated.

In one embodiment of the apparatus, an air passage is disposed in the IPL irradiator.

In one embodiment of the apparatus, the treated-powder discharging line is connected to or includes a cyclone separator to separate the air and the treated-powders from each other.

A powder material processing method according to the present disclosure for achieving the above purpose comprises feeding raw-powders having a polymer coating into a chamber in which air is ejected upwardly, such that the raw-powders supplied into the chamber are suspended in the chamber; applying IPL (Intense Pulsed Light) to the raw-powders to carbonize the polymer coating thereof inwardly from a surface thereof; and discharging treated-powders having the carbonized polymer coating out of the chamber.

In one embodiment of the method, the air is ejected upwardly at a magnitude of an air pressure corresponding to a magnitude of a gravity applied to the raw-powders so that the gravity and a suspending force applied to the raw-powders are balanced with each other to suspend the raw-powders at a predetermined vertical level in the chamber, wherein the treated-powder which becomes lighter than the raw-powder via the carbonization is discharged out of the chamber under the air pressure.

In one embodiment of the method, the method further comprises supplying compressed air from a compressed air supplier into the chamber to transfer the raw-powders into the chamber and to eject the air upwardly.

In one embodiment of the method, the method further comprises monitoring each of a number of the raw-powders supplied into the chamber and a number of the treated-powders discharged out of the chamber.

In one embodiment of the method, the method further comprises separating fine powders from the discharged gas using an electrostatic precipitator, and then resupplying the discharged gas to the compressed air supplier to form a closed loop system.

### Advantageous Effects of Invention

In the present disclosure, only the outer portion of the polymer coating in the thickness direction in the polymer coating powder material may be carbonized via the application of the IPL having a pulse duration of several milliseconds such that the energy may be applied only to a limited depth from a surface of the polymer.

In particular, in accordance with the present disclosure, when the carbonization percentage of the polymer reaches a target value, the polymer is no longer carbonized and escapes to the outside under the air pressure and the gravity, thereby providing uniform carbonization. Furthermore, these processes may be performed in a continuous manner.

### BRIEF DESCRIPTION OF DRAWINGS

Referring to the drawings, several aspects of the present disclosure are shown in detail by way of not limitation but illustration:

FIG. 1 schematically shows an example of a powder material before and after carbonization.

FIG. 2 schematically shows a powder material processing method according to the present disclosure.

FIG. 3 schematically shows a magnitude of each of an air pressure and a gravity to which raw-powders are subjected, before and after carbonization.

FIG. 4 schematically shows a powder material processing apparatus according to an embodiment of the present disclosure.

FIG. 5 schematically shows a powder material processing apparatus according to another embodiment of the present disclosure.

FIG. 6 schematically shows a powder material processing apparatus according to still another embodiment of the present disclosure.

### MODE FOR THE INVENTION

The following descriptions and embodiments as described herein are provided as examples of the principles of the various forms of the present disclosure. These embodiments are provided for purposes of illustrative, non-limiting, descriptions of these principles in the present disclosure in various forms. The same reference numerals have been assigned to similar parts in the descriptions throughout the specifications and drawings. The drawings are not necessarily to scale, and in some cases, the scale may be exaggerated to more clearly depict a certain feature.

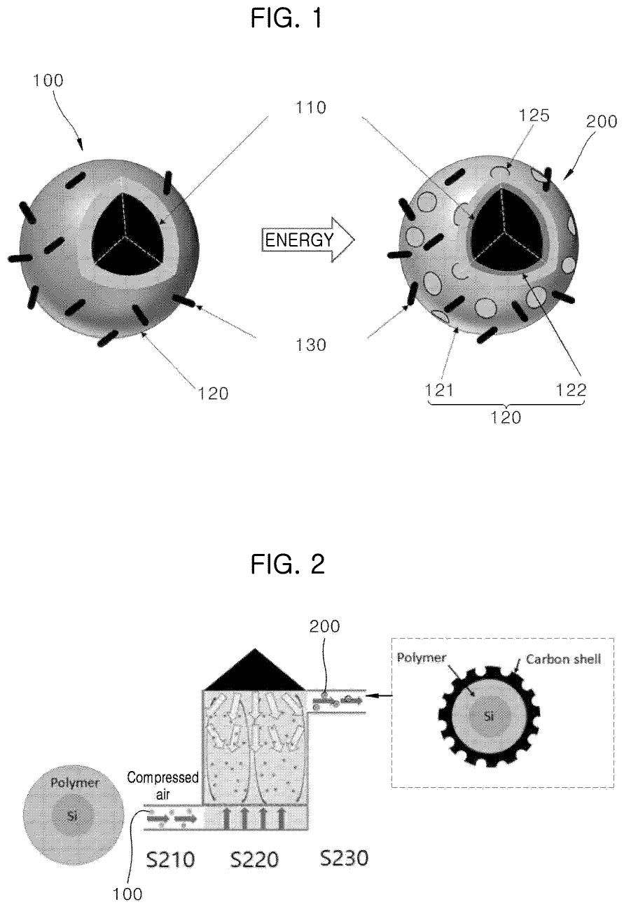

FIG. 1 schematically shows an example of a powder material before and after carbonization.

FIG. 1 illustrates silicon powders that may be used for an anode for lithium secondary batteries such as lithium ion batteries, lithium metal batteries, lithium sulfur batteries, and lithium air batteries, and shows raw-powders 100 before carbonization and treated-powders 200 after carbonization.

Referring to FIG. 1, each of the raw-powders 100 includes a core active material 110 and a polymer coating 120 on a surface of the core active material 110. If necessary, carbon-based additives 130 may be dispersed in the polymer coating 120.

The raw-powder 100 having the polymer coating 120 are subjected to application of IPL (intense pulsed light) such that the surface of the polymer coating 120 is partially or entirely carbonized, thereby producing the treated-powder 200. In FIG. 1, a portion from a surface of the polymer coating is carbonized by the IPL application to produce a resulting treated-powder 200 including an outer shell 121 and an inner shell 122, wherein nanopores 125 are formed in the outer shell. The outer shell 121 may be hard and carbonized, and the inner shell 122 may be soft and not carbonized.

In the treated-powder 200 of FIG. 1, the outer shell 121 provides structural support and, at the same time, provides electrical conductivity to allow a thin and stable solid electrolyte interface to be formed. The inner shell 122 may be made of a relatively soft polymer that is not carbonized to reduce mechanical stress due to the volume change of the active material during lithiation and delithiation. A plurality of nanopores 125 allow the lithium ions to diffuse easily.

FIG. 2 schematically shows a powder material processing method according to the present disclosure.

Referring to FIG. 2, the powder material processing method according to the present disclosure includes a raw-powder feeding step S210, a polymer coating carbonization step using the IPL S220, and a treated-powder discharging step S230.

In the raw-powder feeding step S210, the raw-powders 100, each having the polymer coating are fed into a chamber. Air is blown upwards inside the chamber, and thus, the raw-powders with the polymer coating are suspended or levitated in the chamber. The raw-powders with the polymer coating may be dried into the powder. However, the present disclosure is not necessarily limited thereto. In another example, the raw-powders may be in a form of liquid droplets containing a solvent. In this case, heating means such as a heater may be additionally provided in the chamber to which the IPL is applied, so that the raw-powders are dried and the polymer coating is carbonized. In another example, the raw-powders in the form of liquid droplets may be dried in a drying chamber, and then, the dried raw-powders may be supplied into the chamber to which the IPL is applied.

In order to transfer the raw-powders 100 into the chamber and to spray the air upwards, a compressed air may be supplied from a compressed air supplier into the chamber.

The number of raw-powders 100 supplied into the chamber may be monitored using a powder count counter.

In the polymer coating carbonization step S220 using the IPL, the IPL is applied to the raw-powders 100 having the polymer coating to produce the treated-powder 200 in which the polymer coating is carbonized from a surface thereof. The carbonization amount of the polymer coating may be determined according to the application conditions of the IPL. A pulse duration of the IPL is several milliseconds. Thus, the energy is applied only to a limited depth from the surface of the polymer coating, so that the polymer coating may be partially carbonized. In another example, the pulse duration, a pulse shape, and an application frequency of the IPL may be controlled so that an entirety of the polymer coating is carbonized.

The IPL may be based on a fast-irradiating photoelectromagnetic wave generated from a xenon lamp. A high-intensity pulse of electricity is applied to a xenon gas-filled lamp to excite the xenon gas to a higher energy state which in turn falls to a lower energy state such that photon irradiation occurs. The irradiated energy in the form of the intense pulsed light may be called a flash. The IPL covers a large surface area in a short time and thus has advantages over other electromagnetic energy application processes such as lasers and microwaves. IPL also has a broad pulsed light spectrum, typically in the range of 200 to 1100 nm. A recent IPL apparatus uses a computer-controlled capacitor bank to generate the IPL whose the pulse duration, a pulse interval, a pulse number, and an intensity are controlled. Fluence (radiant energy irradiated onto a surface per unit area) is related to a distance from an energy source to a target surface, an angle of a reflector and an absorbance of the target surface.

The IPL application is more suitable for powder treatment because the IPL may be irradiated onto a large surface area at once.

In the treated-powder discharging step S230, the treated-powder 200 in which the polymer coating is partially or entirely carbonized is discharged out of the chamber. Like the number of raw-powders supplied into the chamber, the number of treated-powders 200 discharged out of the chamber may be monitored using a powder count counter.

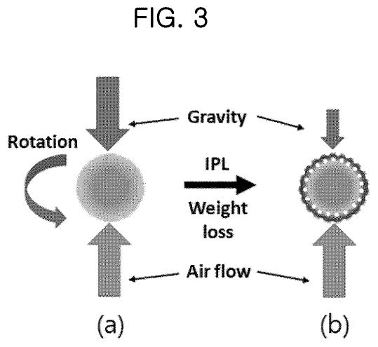

FIG. 3 schematically shows a magnitude of each of an air pressure and a gravity to which the raw-powders are subjected, before and after carbonization.

As in the example shown in (a) of FIG. 3, when a suspending force or a levitating force resulting from the air pressure and the gravity affecting the raw-powder are equal to each other, the raw-powders remain suspended at a predetermined vertical level in the chamber while rotating. In other words, the raw-powders with the polymer coating repeatedly slightly rise up and fall down and eventually are maintained at the predetermined vertical level while rotating in the air due to the air pressure inside the chamber.

As the carbonization of the polymer coating progresses, components except the carbon are removed from the polymer coating such that the weight of the powder decreases. Accordingly, the treated-powders in which the polymer coating is carbonized are subjected to the air pressure greater than the gravity, and as a result, the treated-powders may be discharged out of the chamber by the air pressure.

In accordance with the present disclosure, only the outer portion in the thickness direction of the polymer coating in the polymer coating powder material may be carbonized via the IPL application. In particular, in accordance with the present disclosure, when the carbonization percentage of the polymer reaches a target value, the polymer is no longer carbonized and escapes to the outside, using the air pressure and the gravity, thereby providing uniform carbonization.

When the air pressure is too high, the amount of carbonization of the powders may vary slightly due to the variation in the spacing between the powders and the IPL application distance. However, in accordance with the present disclosure, the uniform carbonization of the polymer coating of the powders may be achieved by preventing the polymer from being carbonized any longer when the carbonization percentage of the polymer reaches the target value, using the balance of the air pressure and the gravity. To this end, in accordance with the present disclosure, the magnitude of the air pressure as applied is set to a value just enough to keep the powders suspended at the specific vertical level.

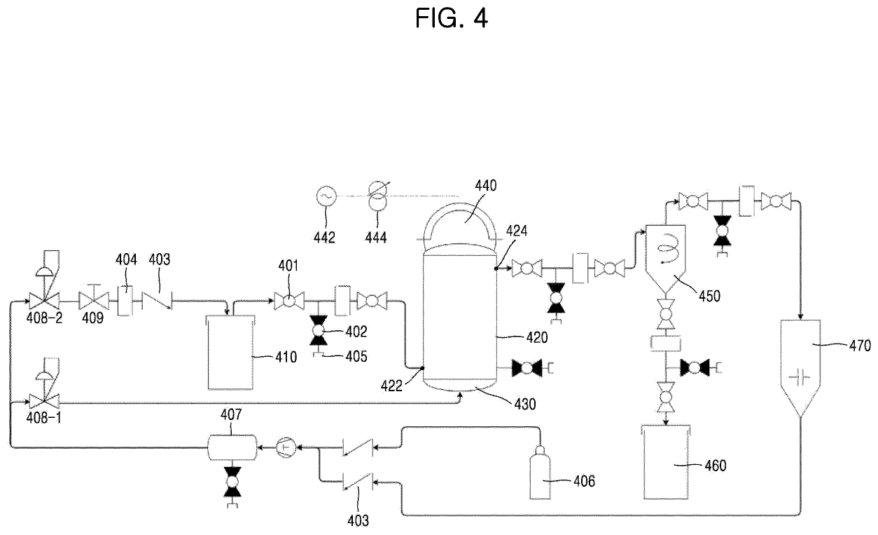

FIG. 4 schematically shows a powder material processing apparatus according to an embodiment of the present disclosure.

Referring to FIG. 4, the powder material processing apparatus according to the present disclosure includes a raw-powder supplier 410, a chamber 420, a gas ejector 430, an IPL irradiator 440, and a treated-powder separator 450 and 470.

The raw-powder supplier 410 is connected to an inlet 422 of the chamber 420 via a raw-powder feeding line so that the raw-powders having the polymer coating are supplied into the chamber. The raw-powder supplier 410 may be embodied in a form of a storage tank, a feedstock hopper, or the like, or may be embodied as a powder drier.

The chamber 420 is a space where the raw-powders are treated by applying energy thereto. An inner surface of the chamber may be a reflective surface that reflects light except for portions corresponding to the inlet 422, an outlet 424, and the IPL irradiator 440.

The gas ejector 430 is disposed at a bottom of the chamber and is connected to the gas supplier 406. The gas supplier 406 connected to the gas ejector 430 may be connected to the raw-powder supplier 410 that supplies the raw-powders for raw-powder transfer. The gas ejector 430 ejects a compressed gas upwardly in the inside of the chamber to suspend the raw-powders in the chamber. The gas may be air, argon, nitrogen or the like.

The gas ejector 430 may suspend the raw-powders at a predetermined vertical level in the chamber by balancing the gravitational force and the suspending force to which the raw-powders are subjected. To balance the gravitational force and the suspending force affecting the raw-powders, the gas ejector may eject the gas upwards at an air pressure corresponding to the gravitational force affecting the raw-powders.

The IPL irradiator 440 carbonizes the polymer coating of the raw-powders. The xenon lamp may be used as the IPL irradiator 440. The IPL irradiator 440 may be electrically connected to an AC power supply 442. An IPL power controller 444 may be disposed between the IPL irradiator 440 and the AC power supply 442.

FIG. 4 shows an example in which the IPL irradiator 440 is disposed on top of the chamber 420 and the IPL is applied in a direction from the top to the bottom. However, the present disclosure is not limited thereto, and the IPL irradiator may be disposed on the side or the bottom of the chamber. In order to increase the IPL application efficiency, the inner surface of the chamber may be composed of a reflective surface.

Furthermore, a temperature of the IPL irradiator 440 may rise according to the IPL application. Thus, an air passage through which air passes may be disposed in the IPL irradiator for cooling. The IPL irradiator may be cooled as the compressed air supplied into the chamber through the air passage passes through the air passage in the IPL irradiator.

The outlet 424 extends through the chamber 420 to discharge the treated-powders in which the polymer coating has been carbonized. The outlet 424 may be positioned at a level higher than the specific level at which the powders are suspended, so that the treated-powders which become lighter than the raw-powders via the carbonization are discharged under the air pressure provided from the gas ejector 430.

The treated-powder separator 450 and 470 separates the gas and the treated-powders from each other. The treated-powder separator may be connected to a cyclone separator 450 or may include the cyclone separator 450. Furthermore, the treated-powder separator may include an electrostatic precipitator 470 to separate fine powders that have not been separated from the gas by the cyclone separator 450. The treated-powders separated using the treated-powder separator may be stored in a powder storage 460. The separated gas may be re-supplied to a gas supply line from the gas supplier 406.

In one example, the powder material processing apparatus may further include a compressed gas supply, i.e., a compressor 407, and a low-pressure regulator 408-1 and a high-pressure regulator 408-2. The low-pressure regulator 408-1 may be connected to the gas ejector. The high-pressure regulator 408-2 may be connected to the inlet 422 of the chamber through the raw-powder feeding line. Compressed gases at different gas pressures may be respectively supplied into the chamber 420 through the inlet 422 and the gas ejector 430 under controls of the low-pressure regulator 408-1 and the high-pressure regulator 408-2.

In FIG. 4, a reference numeral 401 refers to a ball valve, a reference numeral 402 refers to the ball valve in a generally closed state, a reference numeral 403 refers to a one-way check valve, a reference numeral 404 refers to a threaded union, a reference numeral 405 refers to a quick disconnect bleed port, and a reference numeral 409 refers to a flow control valve. These components are necessary for controlling the flow of the gas or powders and for connecting the components to each other.

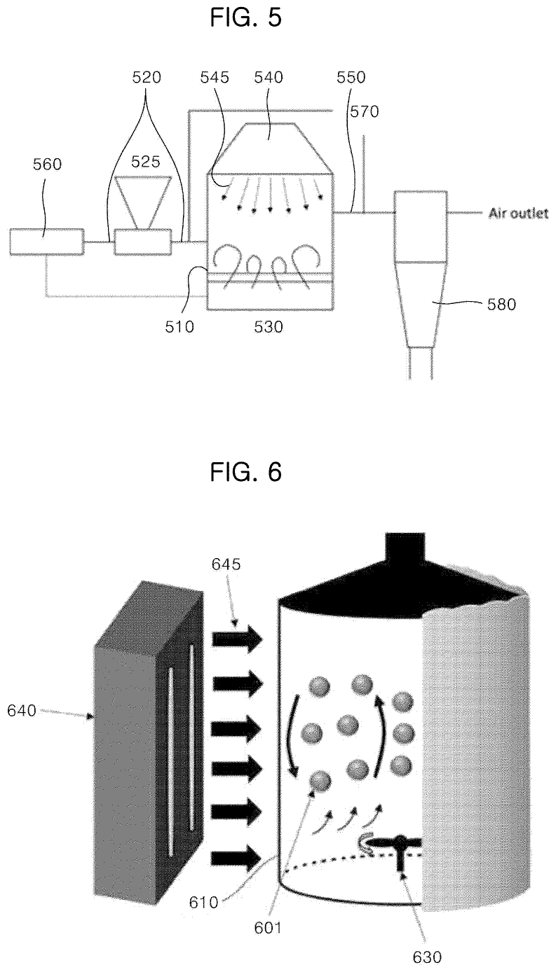

FIG. 5 schematically shows a powder material processing apparatus according to another embodiment of the present disclosure.

Referring to FIG. 5, the powder material processing apparatus according to this embodiment includes a chamber 510, a raw-powder feeding line 520 for feeding the raw-powders into the chamber, a gas ejector 530 for spraying the gas into the chamber, an IPL irradiator 540 that irradiates the IPL 545 into the chamber, a treated-powder discharging line 550 for discharging the treated-powders out of the chamber, and a gas supplier 560 for supplying the compressed gases to the raw-powder feeding line and the gas ejector.

In the powder material processing apparatus as shown in FIG. 5, the chamber 510, the gas ejector 530, and the IPL irradiator 540 are substantially the same as the chamber 420, the gas ejector 430, and the IPL irradiator 440 shown in FIG. 4, respectively.

The raw-powder feeding line 520 is connected to the inlet of the chamber so that the raw-powders having the polymer coating are fed into the chamber. A raw-powder supplier may be disposed at or connected to the raw-powder feeding line 520. In the embodiment as shown in FIG. 5, a feedstock hopper 525 is disposed at the raw-powder feeding line 520.

A treated-powder separator 580 including the cyclone separator and the electrostatic precipitator is disposed at the treated-powder discharging line 550.

The gas supplier 560 supplies the compressed gas to the raw-powder feeding line 520 and the gas ejector 530. The gas supplier 560 may supply the compressed gases at different gas pressures to the raw-powder feeding line 520 and the gas ejector 530, respectively.

Furthermore, in the powder material processing apparatus as shown in FIG. 5, powder number counters 570 may be disposed at the raw-powder feeding line and the treated-powder discharging line, respectively.

The powder processing apparatus according to the present disclosure has a great advantage in that a continuous process as well as a batch process may be realized because the powders that have been carbonized and the powders that have not been carbonized may be easily separated from each other. In the continuous process, an IPL pulse of 5 to 10 milliseconds may be repeatedly applied at an interval of about 1 second to 2 seconds.

Furthermore, the powder processing apparatus according to the present disclosure may form a closed-loop system to prevent gas contamination and continuously reuse the gas. For example, as shown in FIG. 4, the closed loop system may be formed by separating the fine powders from the discharged gas with the electrostatic precipitator and then resupplying the discharged gas to the compressed air supplier.

FIG. 6 schematically shows a powder material processing apparatus according to still another embodiment of the present disclosure.

Referring to FIG. 6, the powder material processing apparatus shown includes a chamber 610, a gas ejector 630, an IPL irradiator 640, a reflector, etc. The raw-powder supplier, the treated-powder separator, etc., may be the same as those exemplified in FIG. 4 or FIG. 5.

Unlike the embodiments as shown in FIGS. 4 and 5, in the embodiment as shown in FIG. 6, the IPL irradiator 640 is disposed on a side wall of the chamber. When the side wall of the chamber is made of a light-transmitting material (glass or transparent polycarbonate, etc.), the IPL irradiator 640 may be placed outside the chamber, and thus, the IPL 645 therefrom may transmit through the side wall of the chamber into the inside of the chamber and then may reach raw-powders 601.

As described above, in the present disclosure, the carbonization of the polymer coating in the polymer coating powder material may be achieved at a target amount via the application of IPL. In particular, in accordance with the present disclosure, when the carbonization percentage of the polymer reaches the target value, the polymer is no longer carbonized and escapes to the outside, under the air pressure and the gravity, thereby providing the uniform carbonization of the powders.

In the above descriptions, the embodiment of the present disclosure has been mainly described, but various changes or modifications may be made at the level of a person skilled in the art. Accordingly, it may be understood that such changes and modifications are included within the scope of the present disclosure as long as they do not deviate from the scope of the present disclosure.

1. An apparatus for processing a powder material, the apparatus comprising:
a chamber;
a raw-powder feeding line for feeding raw-powders having a polymer coating into the chamber;
a gas ejector disposed on a bottom of the chamber so as to eject air upwardly to suspend the raw-powders in the chamber;
an IPL (Intense Pulsed Light) irradiator for carbonizing the polymer coating of the raw-powders; and
a treated-powder discharging line for discharging treated-powders having the carbonized polymer coating out of the chamber.

2. The apparatus of claim 1, wherein the gas ejector ejects the air upwardly at a magnitude of an air pressure corresponding to a magnitude of a gravity applied to the raw-powders so that the gravity and a suspending force applied to the raw-powders are balanced with each other to suspend the raw-powders at a predetermined vertical level in the chamber,
wherein the treated-powder discharging line is positioned at a vertical level higher than the predetermined vertical level so that the treated-powder which becomes lighter than the raw-powder via the carbonization is discharged out of the chamber by the gas ejector.

3. The apparatus of claim 1, wherein the apparatus further comprises a compressed air supplier,
wherein the compressed air supplier is in fluid communication with the raw-powder feeding line and the gas ejector.

4. The apparatus of claim 1, wherein the apparatus further comprises a powder number counter disposed in each of the raw-powder feeding line and the treated-powder discharging line.

5. The apparatus of claim 1, wherein a feedstock hopper is disposed at the raw-powder feeding line, or the raw-powder feeding line is connected to a discharging line of a raw-powder storage or a powder drier.

6. The apparatus of claim 1, wherein the IPL irradiator is disposed on a side surface or an upper surface of the chamber.

7. The apparatus of claim 6, wherein the apparatus further comprises a reflector covering an entirety of an inner surface except for a portion to which the IPL from the IPL irradiator is irradiated.

8. The apparatus of claim 1, wherein an air passage is disposed in the IPL irradiator.

9. The apparatus of claim 1, wherein the treated-powder discharging line is connected to or includes a cyclone separator to separate the air and the treated-powders from each other.

10. A method for processing a powder material, the method comprising:
feeding raw-powders having a polymer coating into a chamber in which air is ejected upwardly, such that the raw-powders are suspended in the chamber;
applying IPL (Intense Pulsed Light) to the raw-powders to carbonize the polymer coating thereof inwardly from a surface thereof; and
discharging treated-powders having the carbonized polymer coating out of the chamber.

11. The method of claim 10, wherein the air is ejected upwardly at a magnitude of an air pressure corresponding to a magnitude of a gravity applied to the raw-powders so that the gravity and a suspending force applied to the raw-powders are balanced with each other to suspend the raw-powders at a predetermined vertical level in the chamber,
wherein the treated-powder which becomes lighter than the raw-powder via the carbonization is discharged out of the chamber under the air pressure.

12. The method of claim 10, wherein the method further comprises supplying compressed air from a compressed air supplier into the chamber to transfer the raw-powders into the chamber and to eject the air upwardly.

13. The method of claim 10, wherein the method further comprises monitoring each of a number of the raw-powders supplied into the chamber and a number of the treated-powders discharged out of the chamber.

14. The method of claim 12, wherein the method further comprises separating fine powders from the discharged gas using an electrostatic precipitator, and then resupplying the discharged gas to the compressed air supplier to form a closed loop system.

15. The apparatus of claim 2, wherein the apparatus further comprises a compressed air supplier,
wherein the compressed air supplier is in fluid communication with the raw-powder feeding line and the gas ejector.

16. The apparatus of claim 2, wherein the apparatus further comprises a powder number counter disposed in each of the raw-powder feeding line and the treated-powder discharging line.

17. The apparatus of claim 2, wherein a feedstock hopper is disposed at the raw-powder feeding line, or the raw-powder feeding line is connected to a discharging line of a raw-powder storage or a powder drier.

18. The apparatus of claim 2, wherein the IPL irradiator is disposed on a side surface or an upper surface of the chamber.

19. The apparatus of claim 2, wherein an air passage is disposed in the IPL irradiator.

20. The apparatus of claim 2, wherein the treated-powder discharging line is connected to or includes a cyclone separator to separate the air and the treated-powders from each other.
